(19) United States
(12) Patent Application Publication
(10) Pub. No.: US 2017/0067764 A1
(43) Pub. Date: Mar. 9, 2017

(54) METHOD AND DEVICE FOR DETECTING AT LEAST ONE SENSOR MALFUNCTION OF AT LEAST ONE FIRST SENSOR OF AT LEAST ONE FIRST VEHICLE

(71) Applicant: Robert Bosch GmbH, Stuttgart (DE)

(72) Inventors: Christian Skupin, Garbsen (DE); Markus Langenberg, Hannover (DE); Daniel Zaum, Sarstedt (DE); Hanno Homann, Hannover (DE); Moritz Michael Knorr, Hildesheim (DE); Lukas Klejnowski, Hannover (DE); Alexander Geraldy, Hildesheim (DE); Michael Pagel, Ludwigsburg (DE); Emre Cakar, Sarstedt (DE); Jochen Marx, Emmerke (DE); Isabella Hinterleitner, Hildeshiem (DE); Holger Mielenz, Ostfildern (DE)

(21) Appl. No.: 15/235,005

(22) Filed: Aug. 11, 2016

(30) Foreign Application Priority Data
Aug. 28, 2015 (DE) 102015216494.2

(51) Int. Cl. G01D 18/00; G07C 5/00; G07C 5/08

(52) U.S. Cl. CPC G01D 18/00; G07C 5/0816; G07C 5/008

(57) ABSTRACT

A method and a device for detecting at least one sensor malfunction of at least one first sensor of at least one first vehicle, at least one first signal from the at least one first sensor of the at least one first vehicle being ascertained and this at least one first signal being compared according to predefined comparison criteria to at least one comparison variable, at least one further second signal from at least one second sensor of at least one further second vehicle being ascertained as this at least one comparison variable and the at least one sensor malfunction being detected in the at least one first vehicle as a function of the comparison.

### CROSS REFERENCE

The present application claims the benefit under 35 U.S.C. §119 of German Patent Application No. DE 102015216494.2 filed on Aug. 28, 2015, which is expressly incorporated herein by reference in its entirety.

### FIELD

The present invention relates to a method and a device for at least one vehicle for detecting at least one sensor malfunction of at least one sensor. To ascertain this at least one sensor malfunction, at least one further vehicle, also having at least one sensor, is regarded for comparison of the sensor values. After comparison of these sensor values, which takes place according to predefined comparison criteria, the sensor malfunction is determined and the piece of information about it is processed accordingly.

### BACKGROUND INFORMATION

Conventional methods for detecting sensor malfunctions may be carried out both by direct readout of a control unit, and via data transmission in a repair shop. The sensor functions are checked in that signals are detected by the sensors to be tested and the signals are compared to known signals. If differences are shown which exceed a specific tolerance, the sensors are classified as defective, otherwise as free of defects.

Such a method for providing information for driver assistance systems, inter alia, by checking measuring data obtained by surroundings sensors, is described in German Patent Application No. DE 10 2008 013 366 A1. This is carried out by so-called measuring data hypotheses or object hypotheses inside the motor vehicle which provides the surroundings sensors. Measuring data features are derived both on the basis of present measuring data and on the basis of past measuring data and these features are compared to one another.

### SUMMARY

An example method according to the present invention and example device according to the present invention for detecting at least one sensor malfunction of at least one first sensor of at least one first vehicle, at least one first signal from the at least one first sensor of the at least one first vehicle, being ascertained, includes comparing this at least one first signal, according to predefined comparison criteria, to at least one comparison variable.

In accordance with the present invention, at least one comparison variable is ascertained as a function of at least one further second signal from at least one second sensor of at least one further second vehicle and the at least one sensor malfunction in the at least one first vehicle is detected as a function of the comparison.

The advantage of the present invention is that sensor malfunctions may also be detected if the sensor functions per se and a faulty signal is only detected due to certain circumstances, for example, induced by external conditions. In addition, both temporary malfunctions and permanent malfunctions may be detected by this method. Due to the comparison according to the present invention of the sensor signals of the sensors installed in different vehicles, in addition, a total of more than one individual sensor also participates in the detection of a signal, whereby the reliability that the signal is correctly detected by at least one sensor is increased. This plays a large role in the safety of a vehicle driven by a driver, but above all in the case of vehicles which drive in a partially or completely automated manner and in which the monitoring of the vehicles by sensors plays a necessary and also leading role.

The at least one first sensor of at least one first vehicle will preferably acquire an acquired variable, which is predefined according to acquisition criteria. The at least one sensor malfunction exists if the at least one first sensor of at least one first vehicle detects this detection variable according to predefined detection criteria incorrectly or not at all.

It may be an advantage of the present invention that the method may detect a malfunction both within the meaning of a false estimation and a total failure of a sensor. The false estimation is even detected if the sensor functions per se but, due to certain circumstances, for example, external conditions, still supplies a signal or also multiple signals with deficient accuracy or supplies a signal which results in an incorrect conclusion, for example, not recognizing an obstruction. The informative value of a signal recorded by a sensor, and the confidence, for example, of a user of the mobile unit, in the sensors of a vehicle may thus be generally increased.

In one particularly preferred specific embodiment, this at least one comparison variable is detected in the at least one first vehicle and/or in the at least one further second vehicle and/or outside the at least one first vehicle and outside the at least one further second vehicle in detection surroundings provided for this purpose. The latter alternative is also often referred to as a data cloud.

In addition, the at least one sensor malfunction is preferably displayed in the at least one first vehicle, and/or data values, which represent the at least one sensor malfunction, are stored in the at least one first vehicle and/or in the at least one further second vehicle and/or on at least one external storage medium, for example, in a so-called data cloud. In addition, the data values may be transmitted to at least one user of the at least one first vehicle and/or the at least one further second vehicle.

The advantages of these preferred specific embodiments result from the manifold potential uses which result from the information of the comparison variable. By way of the detection in the at least one first vehicle, the safety may be increased for the user of the at least one first vehicle and an instantaneous adaptation to safety-relevant conditions may be enabled, for example, the lack of recognition of hazards due to severe visibility restriction, induced by corresponding external conditions. Improvements with respect to the safety during automated driving, for example, also result due to the detection outside the at least one first vehicle.

Preferably, the data of the at least one first sensor of the at least one first vehicle and/or the data of the at least one second sensor of the at least one further second vehicle are stored in a database. In addition, it may be decided according to predefined criteria whether the at least one first sensor of the at least one first vehicle and the at least one second sensor of the at least one further second vehicle are structurally identical and/or comparable. In this preferred embodiment of the method according to the present invention, in addition to the at least one detected signal of the at least one first vehicle and the comparison to at least one further signal of at least one further second vehicle, the design of the sensors involved in the method is also taken into consideration. The quality of the detection according to the method of at least one sensor malfunction is thus increased. In addition, typical sensor malfunctions may also be stored in such a database, whereby regular malfunctions which have already occurred in the past may also be used to judge the at least one sensor malfunction.

In one preferred specific embodiment, at least one average value is determined according to predefined criteria as the at least one comparison variable, which is ascertained as an average of the at least one further second signal and at least one additional third signal from at least one additional third sensor, of at least one additional third vehicle, and/or the at least one further second vehicle.

A further improvement of the quality of the at least one detected sensor malfunction is shown here. Due to the contribution of at least one additional third signal of at least one additional third vehicle and/or the at least one further second vehicle, the accuracy of the comparison variable increases, and therefore also the confidence, for example, of a user of the mobile unit, in the sensors of a vehicle.

The at least one sensor malfunction is preferably detected as a function of surroundings values, which represent the surroundings of the at least one first vehicle and/or the surroundings of the at least one further second vehicle.

In addition, the at least one sensor malfunction is preferably a function of the surroundings values, which represent the surroundings of the at least one first vehicle and/or the surroundings of the at least one further second vehicle.

The advantages of the dependence of the detection of the at least one sensor malfunction on the surroundings values and/or the dependence of the at least one sensor malfunction on the surroundings values enable, especially in the case of external conditions which strongly restrict the detection of the at least one first signal of at least one first sensor of the at least one vehicle, for example, in the event of rain, fog, and/or significant dust in the surroundings of the at least one first vehicle, a significant improvement of the safety-relevant surroundings of the at least one first vehicle.

According to the present invention, a device for detecting at least one sensor malfunction of at least one first sensor of at least one first vehicle is provided, first means being provided, with the aid of which at least one first signal from the at least one first sensor of the at least one first vehicle may be ascertained, and second means being provided, with the aid of which this at least one first signal may be compared according to predefined comparison criteria to at least one comparison variable. The device furthermore includes third means, with the aid of which this at least one comparison variable is ascertained as a function of at least one further second signal from at least one second sensor of at least one further second vehicle, and fourth means, with the aid of which the at least one sensor malfunction in the at least one first vehicle is detected as a function of the comparison.

In one particularly preferred specific embodiment, the device furthermore includes fifth means, with the aid of which the at least one sensor malfunction exists if the at least one first sensor incorrectly detects this detection variable according to predefined detection criteria.

The device particularly preferably includes a sixth means, with the aid of which the at least one sensor malfunction may be displayed in the at least one first vehicle, and/or seventh means for storage, with the aid of which data values, which represent the at least one sensor malfunction, may be stored in the at least one first vehicle and/or in the at least one further second vehicle. Furthermore, the device includes eighth means, with the aid of which the at least one sensor malfunction may be transmitted to at least one user of the at least one first vehicle and/or the at least one further second vehicle.

In one particularly preferred specific embodiment, the device includes ninth means, with the aid of which it may be decided according to predefined criteria whether the at least one first sensor of the at least one first vehicle and the at least one second sensor of the at least one further second vehicle are structurally identical and/or comparable. Furthermore, the device includes tenth means, with the aid of which at least one average value may be determined according to predefined criteria as the comparison variable, and/or eleventh means, with the aid of which the at least one sensor malfunction is detected as a function of surroundings values, which represent the surroundings of the at least one first vehicle and/or the surroundings of the at least one further second vehicle.

Advantageous refinements of the present invention are described herein.

### BRIEF DESCRIPTION OF THE DRAWINGS

Exemplary embodiments of the present invention are shown in the figures and are explained in greater detail below.

FIG. 1 shows two vehicles, which exchange data, relating to signals detected by sensors, via car2infrastructure communication.

FIG. 2 shows an exemplary embodiment of a method according to the present invention for detecting at least one sensor malfunction with the aid of car2infrastructure communication or car2car communication.

### DETAILED DESCRIPTION OF EXAMPLE EMBODIMENTS

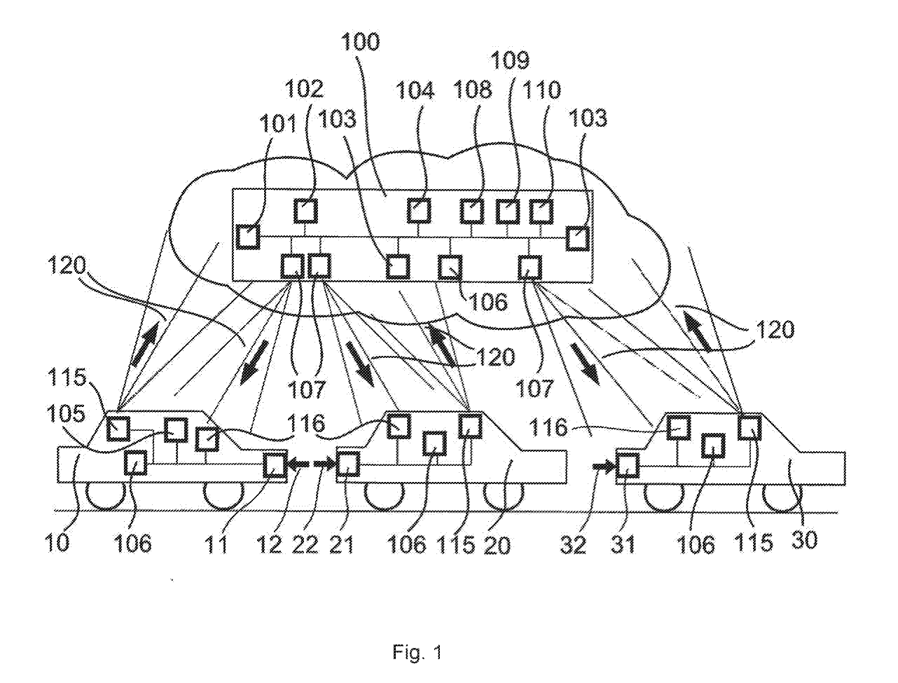

FIG. 1 shows an exemplary situation of the method according to the present invention for detecting at least one sensor malfunction of at least one first sensor 11 of at least one first vehicle 10. For illustration, in this specific embodiment, the method is shown, solely by way of example, on the basis of a sensor malfunction of a first sensor 11 of a first vehicle 10. The method is basically also suitable for detecting multiple sensor malfunctions of multiple sensors, which may be attached both to one and to multiple vehicles involved in the method.

In this exemplary embodiment, which is here solely by way of example, all vehicles 10, 20, 30 involved in the method are illustrated as four-wheeled vehicles. The method is expressly applicable for vehicles of all types, which includes both manned and unmanned vehicles, and also vehicles on land, water, or also in the air.

According to the present invention, a signal 12, shown as an arrow here, is detected by a first vehicle 10 with the aid of a sensor 11. It is generally possible that this detected signal 12 either supplies a piece of information, for example, about the surroundings of first vehicle 10, which results in a false estimation of a possibly existing hazardous situation or, in the extreme case, such a hazardous situation is not recognized at all. It may also be a faulty signal 12, which occurs because sensor 11 is defective or is inoperable. Both cases are referred to according to the present invention as sensor malfunctions.

These sensor malfunctions may be extremely relevant both to a user of first vehicle 10 and to an automated vehicle, the functioning of which is decisively dependent on the sensors available thereto. Therefore, the sensor malfunction is also displayed to a user of first vehicle 10 with the aid of suitable means 105. It is furthermore provided that the sensor malfunction is also stored in vehicles 10, 20, 30, which are involved in the method, on a storage medium 106, in vehicles 10, 20, 30, as shown here solely by way of example, or also outside the vehicles in an external device 100, which is generally referred to as the cloud. It is furthermore possible that the sensor malfunction is also transmitted to users of vehicles 10, 20, 30, which, according to the present invention, may be located both inside vehicles 10, 20, 30, and outside, for example, in the case of automated and/or remote-controlled vehicles 10, 20, 30.

In the present invention, signal 12 is detected by first sensor 11 of first vehicle 10 and compared to a comparison variable, which is ascertained as second signal 22 of a second sensor of a second vehicle 20. Ideally, an average value, which was formed as the average of multiple signals 22, 32 of multiple sensors 21, 31, is used as the comparison variable. In the exemplary embodiment described here, solely by way of an example, two signals 22, 32 of a second sensor 21 of a second vehicle 20 and a third sensor 31 of a third vehicle 30 are used to provide an average variable. In general, however, it is also possible that two signals 22, 32 of two sensors 21, 31 on only a second vehicle 20 are used to form an average variable.

The method according to the present invention is carried out by a device 100, which is shown here as a cloud solely by way of example. In general, this is understood as one or also multiple server(s), which has/have a location independent of vehicles 10, 20, 30 and exchange data with vehicles 10, 20, 30 with the aid of data transmission capabilities, a so-called car2infrastructure communication, for example, WLAN connections, which are indicated here by dashed lines 120. The method according to the present invention also provides that device 100 may also be located inside one of vehicles 10, 20, 30 involved in the method. The method-relevant data are exchanged between the vehicles, which is generally referred to as car2car communication.

According to the present invention, means 115 are provided on vehicles 10, 20, 30, with the aid of which vehicles 10, 20, 30 may transmit data to device 100, and also further means 106, with the aid of which vehicles 10, 20, 30 may receive data from device 100.

Device 100 includes, independently of whether it is a cloud as shown here solely by way of example, i.e., a device which provides the method outside vehicles 10, 20, 30, or also a device 100, which is associated with one of vehicles 10, 20, 30 shown by way of example, means 101 with the aid of which signal 12 may be detected, which is to be compared to a comparison variable for a sensor malfunction within the meaning of the above-described definition. This comparison variable is detected by means 103, which may detect both signal 22 of second signal 21 of second vehicle 20 and signal 32 of third sensor 31 of third vehicle 30.

The device furthermore includes means 102, shown here solely by way of example, with the aid of which signal 12, which was ascertained by sensor 11 of first vehicle 10, is compared to the comparison variable. After the comparison has been carried out, a sensor malfunction within the meaning of the above-described definition of sensor 11 of first vehicle 10 is detected here by means 104, which are shown solely by way of example.

Furthermore, the device, as shown here solely by way of example, furthermore includes means 108, with the aid of which it is determined whether sensors 11, 21, 31 are structurally identical and/or comparable. This may be a database, for example, in which all or parts of sensors 11, 21, 31 which come into consideration are stored. Already known sensor malfunctions may also be stored in this database, for example, which makes recognition of a sensor malfunction of sensor 11 easier. In conjunction with means 109, which are shown here solely by way of example and which determine an average value from second signal 22 of second sensor 21 of second vehicle 20 and third signal 32 of third sensor 31 of third vehicle 30, the detection of the sensor malfunction with the aid of means 104 is facilitated.

Since the sensor malfunction of sensor 11, which is shown here solely by way of example, of first vehicle 10 may take place as a result of the surroundings, as already explained above, for example, due to rain, dust, fog, and snow, the method according to the present invention may also be carried out as a function of surroundings values, which may be obtained by means 110, which are shown here solely by way of example.

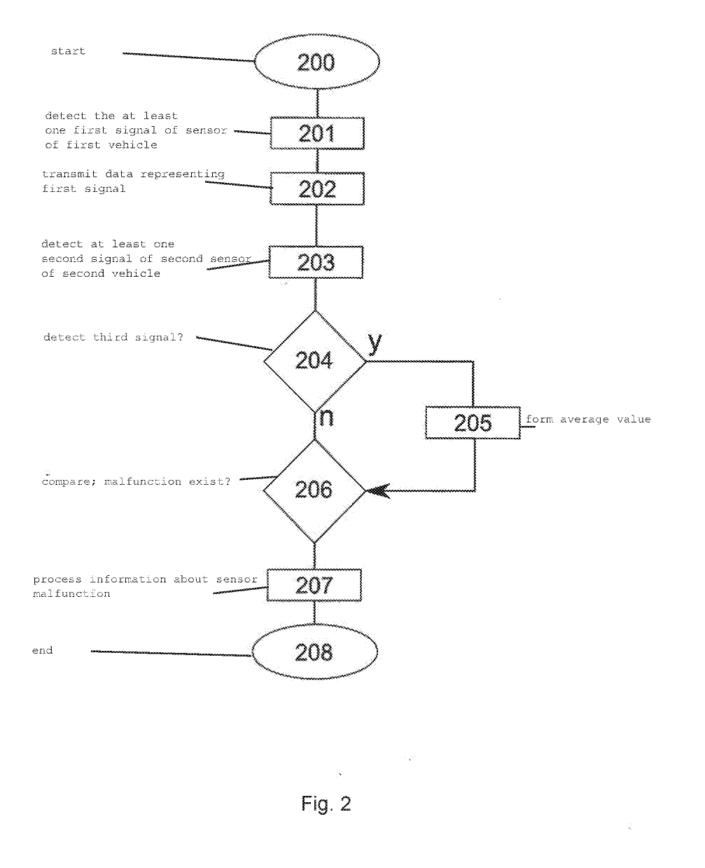

FIG. 2 schematically shows an exemplary embodiment of a method according to the present invention.

In step 200, the method is started.

In step 201, the at least one first signal 12 of the at least one first sensor 11 of the at least one first vehicle 10 is detected.

In step 202, the data which represent the at least one first signal 12 are transmitted to device 100 according to the present invention.

In step 203, at least one further second signal 22 of at least one further second sensor 21 of at least one further second vehicle 20 is detected.

In step 204, it is checked whether at least one further third signal 32 of at least one further third sensor 31 of either a further third vehicle 30 and/or the at least one further second vehicle 20 may be detected. If this at least one further third signal 32 may be detected, step 205 follows, otherwise step 206 follows.

In step 205, an average value, which is used as a comparison variable, is formed from the at least one further signal 22 of the at least one further second sensor 21 and the at least one further third signal 32 of the at least one further third sensor 31.

In step 206, the at least one first signal 12 of the at least one first sensor 11 of the at least one first vehicle 10 is compared to the comparison variable and it is ascertained on the basis of the comparison whether at least one sensor malfunction exists.

In step 207, a piece of information about the at least one sensor malfunction is processed, i.e., for example, relayed to at least one user of the at least one first vehicle 10 and/or displayed in the at least one first vehicle by display means 105 and/or stored on at least one storage medium 106.

In step 208, the method ends.

What is claimed is:

1. A method for detecting at least one sensor malfunction of at least one first sensor of at least one first vehicle, comprising:
ascertaining at least one first signal by the at least one first sensor of the at least one first vehicle;
comparing the at least one first signal according to predefined comparison criteria to at least one comparison variable;
wherein the at least one first comparison variable is ascertained as a function of at least one further second signal from at least one second sensor of at least one further second vehicle and the at least one sensor malfunction in the at least one first vehicle is detected as a function of the comparison.

2. The method as recited in claim 1, wherein a detection variable, which is predefined according to detection criteria, is detected by the at least one first sensor of at least one first vehicle, and the at least one sensor malfunction exists if the at least one first sensor of at least one first vehicle detects the detection variable incorrectly or not at all according to predefined detection criteria.

3. The method as recited in claim 1, wherein the at least one comparison variable is obtained at least one of:
in the at least one first vehicle,
in the at least one further second vehicle, and
outside the at least one first vehicle and outside the at least one further second vehicle in detection surroundings provided.

4. The method as recited in claim 1, wherein at least one of:
the at least one sensor malfunction is displayed in the at least one first vehicle,
data values which represent the at least one sensor malfunction are stored at least one of: in the at least one first vehicle, in the at least one further second vehicle, and on at least one external storage medium, and
the at least one sensor malfunction is transmitted to at least one of: at least one user of the at least one first vehicle, and at least one user of the at least one further second vehicle.

5. The method as recited in claim 1, wherein at least one of:
data of the at least one first sensor of the at least one first vehicle is stored in a database, and
data of the at least one second sensor of the at least one further second vehicle is stored in a database.

6. The method as recited in claim 1, further comprising:
determining according to predefined criteria whether the at least one first sensor of the at least one first vehicle and the at least one second sensor of the at least one further second vehicle are at least one of structurally identical and comparable.

7. The method as recited in claim 1, wherein at least one average value is determined according to predefined criteria as the at least one comparison variable, which is ascertained as an average of the at least one further second signal and at least one additional third signal from at least one additional third sensor of at least one of: at least one additional third vehicle and the at least one further second vehicle.

8. The method as recited in claim 1, wherein the at least one sensor malfunction is detected as a function of surroundings values which represent at least of:
surroundings of the at least one first vehicle, and
surroundings of the at least one further second vehicle.

9. The method as recited in claim 8, wherein the at least one sensor malfunction is a function of the surroundings values which represent the at least one of the surroundings of the at least one first vehicle, and the surroundings of the at least one further second vehicle.

10. A device for detecting at least one sensor malfunction of at least one first sensor of at least one first vehicle, the device comprising:
first means with the aid of which at least one first signal from the at least one first sensor of the at least one first vehicle may be ascertained;
second means with the aid of which the at least one first signal may be compared according to predefined comparison criteria to at least one comparison variable;
third means with the aid of which the at least one comparison variable is ascertained, as a function of at least one further second signal from at least one second sensor of at least one further second vehicle; and
fourth means with the aid of which the at least one sensor malfunction in the at least one first vehicle is detected as a function of the comparison.

11. The device as recited in claim 10, further comprising at least one of:
fifth means with the aid of which the at least one sensor malfunction may be displayed in the at least one first vehicle;
sixth means for storage with the aid of which data values, which represent the at least one sensor malfunction, may be stored at least one of in the at least one first vehicle, in the at least one further second vehicle, and outside a vehicle; and
seventh means with the aid of which the at least one sensor malfunction may be transmitted to at least one user of at least one of the at least one first vehicle and the at least one further second vehicle.

12. The device as recited claim 11, further comprising at least one of:
eighth means, with the aid of which it may be decided according to predefined criteria whether the at least one first sensor of the at least one first vehicle and the at least one second sensor of the at least one further second vehicle are structurally one of identical and comparable;
ninth means, with the aid of which at least one average value may be determined as the comparison variable according to predefined criteria; and
tenth means, with the aid of which the at least one sensor malfunction is detected as a function of surroundings values, which represent at least one of surroundings of the at least one first vehicle, and surroundings of the at least one further second vehicle.
